(19) United States
(12) Patent Application Publication
(10) Pub. No.: US 2009/0248241 A1
(43) Pub. Date: Oct. 1, 2009

(54) AUTOMOTIVE RECORDER

(75) Inventors: Hidetoshi ISHII, Tokyo (JP); Yukio Fujisawa, Tokyo (JP); Fumihide Kitamura, Tokyo (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/409,563

(22) Filed: Mar. 24, 2009

(30) Foreign Application Priority Data
Mar. 31, 2008 (JP) 2008-089303

(51) Int. Cl. G06F 19/00; G06F 12/00; G06F 3/00; G06F 13/00

(52) U.S. Cl. 701/35; 710/52; 711/103; 711/104; 711/E12.001; 711/E12.008

(57) ABSTRACT

Functional information acquired before and after an event occurrence is held on an on-chip MRAM built in a data processor, thus preventing the held functional information from being falsified and erased. An automobile recorder of the present invention comprises a one-chip data processor coupled to signal lines transmitting functional information indicating vehicle conditions and an external memory. The data processor comprises an input circuit which takes input of functional information, an MRAM for temporarily storing functional information, and a central processing unit (CPU). The CPU performs wrap-around control for storing functional information into the MRAM. The CPU also performs disabling control for disabling storing of functional information when the amount of new information being stored on the MRAM by wrap-around control in response to and following a certain event occurrence has reached a specific quantity that is less than a storage capacity from the initial address to the end address. Thereby, the on-chip MRAM can hold functional information acquired before and after an event occurrence.

### CROSS-REFERENCE TO RELATED APPLICATIONS

The disclosure of Japanese Patent Application No. 2008-89303 filed on Mar. 31, 2008 including the specification, drawings and abstract is incorporated herein by reference in its entirety.

### BACKGROUND OF THE INVENTION

The present invention relates to an automotive recorder for storing conditions of a vehicle with regard to vehicles such as automobiles and motorcycles (in the present application, the vehicles refer to all kinds of vehicles and conveyances including aircraft, shipping, and others). The invention relates to a drive recorder for, e.g., automobile use for storing information about running speed, engine revolving speed, turning signal operation, seatbelt wearing, etc.

A drive recorder for storing information about vehicle running speed and visual and aural information in the circumference of the vehicle is utilized as the one providing important evidence when investigating the cause of an accident, a fault, abrupt acceleration, abrupt deceleration, and the like. Such information is held on an internal memory, an external memory, etc. of the drive recorder. In particular, old information which has previously been written is rewritten with new information and the new information is held. Therefore, a memory with a high rewriting durability is required as a memory that is used in the drive recorder. An MRAM (Magnetoresistive Random Access Memory) has lately attracted attention as a magnetic storage element having a high rewriting durability and capable of holding information even in a power-off state. As for a drive recorder in which this MRAM is mounted, a technique for simplifying a memory configuration of the drive recorder is proposed in, e.g., Patent Document 1. Specifically, as the MRAM having a RAM (Random Access Memory) area and a ROM (Read Only Memory) area is mounted, there is no need for providing an additional RAM or ROM along with the MRAM.

In a drive recorder disclosed in Patent Document 2, an MRAM is mounted that has a recording area for holding information indicative of vehicle conditions as well as a flag area indicating permission or no permission for storing information into the recording area. It is set forth in Patent Document 2 that the flag area is used to, when en event occurs, set a store flag for information acquired before the event occurrence.

In Patent Document 3, it is set forth that visual information is written into an MRAM provided outside a data processor and writing to the MRAM is disabled by timer control, when an event occurs.

### [Patent Document 1]

Japanese Unexamined Patent Publication No. 2003-104137

### [Patent Document 2]

Japanese Unexamined Patent Publication No. 2006-253847

### [Patent Document 3]

Japanese Unexamined Patent Publication No. 2002-369127

### SUMMARY OF THE INVENTION

The present inventors examined that an on-chip MRAM built in a data processor provided in a drive recorder is adapted to retain functional information representing vehicle conditions before and after an event occurrence. The storage capacity of the on-chip MRAM built in the data processor is finite and smaller than the storage capacity of an external MRAM which can be situated outside the data processor. If a part of the on-chip MRAM is allocated for the flag area, as set forth in Patent Document 2, the storage capacity of the functional information storing area further shrinks.

As in Patent Document 3, when writing of visual information into the MRAM is disabled by timer control, information acquired after an event occurrence is held, but no consideration is taken for information existing before the event occurrence. If information is written into the MRAM in a wrap-around fashion, there is a fear that information existing before an event occurrence is overwritten with information acquired after the event occurrence.

An object of the present invention is to provide an automobile recorder that holds functional information acquired before and after an event occurrence on an on-chip MRAM built in a data processor.

Another object of the present invention is to provide an automobile recorder that prevents falsification and erasure of held functional information acquired before and after an event occurrence.

The above-noted and other objects and novel features of the present invention will become apparent from the following description in the present specification and the accompanying drawings.

A typical aspect of the invention disclosed herein is summarized as follows.

An automobile recorder of the present invention comprises a one-chip data processor coupled to signal lines transmitting functional information indicating vehicle conditions functional parts mounted in the vehicle and an external memory. The data processor comprises an input circuit which takes input of the functional information, an MRAM for temporarily storing the functional information, and a central processing unit. The central processing unit performs storing control (called wrap-around control) for storing the functional information into the MRAM with access address circulation in a range from an initial address to an end address. The CPU also performs disabling control for disabling storing of the functional information when the amount of new information being stored on the MRAM by the wrap-around control in response to and following a certain event occurrence has reached a specific quantity that is less than a storage capacity from the initial address to the end address. Thereby, the on-chip MRAM into which the functional information is stored in a wrap-around fashion can hold the functional information acquired before and after an event occurrence.

Effects obtained by the typical aspect of the invention disclosed herein are outlined below.

Functional information acquired before and after an event occurrence can be held on the on-chip MRAM built in the data processor.

The functional information acquired before and after an event occurrence, once held on the MRAM, can be prevented from being falsified and erased.

### BRIEF DESCRIPTION OF THE DRAWINGS

FIG. 1 shows an example of a network system which is used for electronic control of an automobile.

FIG. 2 is a block diagram of an automobile recorder which is embodied by the automobile electronic control unit.

FIG. 3 shows a control flow of storing CAN information and SC information during ordinary operation.

FIG. 4 shows a control flow of storing CAN information and SC information when an event has occurred.

FIG. 5 shows detailed particular examples of information which are input via the CAN interface circuit 11_1 and the sensor input circuit 11_2 and exemplifies how respective items of information are recorded by the recorder differently depending on the automobile operating circumstances.

FIG. 6 shows a hierarchical structure of three stages of memories.

### DETAILED DESCRIPTION OF THE PREFERRED EMBODIMENTS

### 1. Outlines of Embodiments

To begin with, typical embodiments of the invention disclosed herein are outlined. In the following general description of typical embodiments, reference numbers in the drawings, which are given in parentheses, only denote examples of entities included in the concepts of the components to which the reference numbers are attached.

[1] An automobile recorder (1) in accordance with a typical embodiment of the present invention comprises a one-chip data processor (10) coupled to signal lines transmitting functional information relevant to functional parts mounted in a vehicle and an external memory (20) coupled to the data processor. The data processor comprises an input circuit (11_1, 11_2) which takes input of functional information from the signal lines, an internal memory (12) comprising an MRAM for temporarily storing functional information taken in by the input circuit from the signal lines, and a central processing unit (13). The central processing unit performs wrap-around control for storing the functional information into the internal memory with access address circulation in a range from an initial address to an end address and saving control for saving the functional information before being overwritten by the access address circulation from the internal memory to the external memory. The central processing unit also performs disabling control for disabling storing of functional information by the wrap-around control when the amount of new information being stored on the internal memory by the wrap-around control in response to and following a certain event occurrence has reached a specific quantity. The specific quantity is less than a storage capacity from the initial address up to the end address. Thereby, the functional information acquired before and after the certain event occurrence can be held on the internal memory. Since the internal memory built in the data processor is an on-chip one, the functional information once held can be prevented from being falsified.

In one particular embodiment, the specific quantity is specified in terms of time that elapses after the certain event occurrence. Thereby, it is possible to alter the amount of the functional information allowed to be stored on the MRAM after the certain event occurrence.

In another particular embodiment, the specific quantity is specified in terms of the number of times the memory is accessed after the certain event occurrence. As in the case that the specific quantity is specified in terms of time as above, it is possible to alter the amount of the functional information allowed to be stored on the MRAM after the certain event occurrence.

In another particular embodiment, the central processing unit includes a first register in which control data for determining the specific quantity is set programmably. Thereby, the central processing unit is able to alter the amount of the functional information allowed to be stored and held on the MRAM before and after the certain event occurrence.

In another particular embodiment, the input circuit includes a second register in which selection control data for selectively inputting one of a plurality of items of functional information transmitted through the signal lines is set programmably. Thereby, a desired item of the functional information input to the input circuit can be selected and stored on the internal memory.

In another particular embodiment, the central processing unit may reduce the frequency of storing functional information by the wrap-around control, which is performed in response to the certain event occurrence, in comparison with the frequency of storing functional information by the wrap-around control before the event occurrence. Thereby, information acquired after the certain event occurrence can be shrunk and stored on the MRAM.

In another particular embodiment, the functional information comprises one or more items of control information among power train system control information, chassis system control information, and body system control information.

In another particular embodiment the central processing unit recognizes the occurrence of the certain event by the fact that a value of acceleration acquired from an acceleration sensor or a value of impact acquired from an impact sensor has exceeded a predefined value. That is, due to a vehicular accident, fault, or the like with acceleration or impact exceeding the predefined value, the certain event occurs.

In another particular embodiment, the external memory comprises an MRAM. By using the MRAM that can be rewritten and read an unlimited number of times as the external memory, it is possible to lessen deterioration attributable to rewriting and reading.

[2] Another automobile recorder (1) of the present invention comprises a data processor (10) coupled to signal lines transmitting functional information relevant to functional parts mounted in a vehicle and having an on-chip buffer memory (12) comprising an MRAM for temporarily storing the functional information taken in from the signal lines. The automobile recorder further comprises a working memory (20) which is coupled to the data processor and to which the functional information held on the buffer memory is transferred and an external storage device (40) for storing the functional information once held on the working memory. Thereby, since the buffer memory is an on-chip one, the functional information held on the buffer memory can be prevented from being falsified. By provision of the external storage device, the functional information can be held for a long period.

In one particular embodiment, the data processor performs wrap-around control for storing the functional information into the buffer memory with access address circulation in a range from an initial address to an end address and saving control for saving the functional information that is going to be overwritten by the access address circulation from the buffer memory to the working memory. The data processor also performs disabling control for disabling storing of functional information by the wrap-around control when the amount of new information being stored on the buffer memory by the wrap-around control in response to and following a certain event occurrence has reached a specific quantity that is less than a storage capacity from the initial address up to the end address. The data processor further performs logging control for selectively storing the functional information held on the working memory into the external storage device. Thereby, the functional information acquired before and after the certain event occurrence can be held on the buffer memory.

[3] A buffer memory system in accordance with another aspect of the present invention comprises a first memory (12) comprising an MRAM, a second memory (20) comprising an MRAM into which data held on the first memory is written and which has a larger storage capacity than the first memory, and a third memory (40) comprising an nonvolatile memory into which data held on the second memory is written and which has a larger storage capacity than the second memory, but can only be rewritten a significantly smaller number of times in comparison with MRAM.

Thus, with regard to storage capacity, there is a relation that the first memory<the second memory<the third memory. If the second memory does not exist, the number of times data held on the first memory having only a small storage capacity is written into the third memory increases and this accelerates the rate of progression of deterioration in the rewrite performance of the third memory. Because the storage capacity of the second memory is larger than that of the first memory, accordingly, provision of the second memory can slow down the rate of progression of deterioration in the rewrite performance of the third memory. Hence, the three-stage buffer system according to the present invention can contribute to lengthening the life of the third memory.

The first memory is an on-chip memory mounted on a microcomputer chip implemented in a semiconductor integrated circuit. The second memory is a memory externally coupled to a microcomputer, for example. Further, the third memory may be, for example, a flash memory or a hard disk drive, wherein the flash memory may be implemented as a so-called memory card.

### 2. Details of Embodiments

Embodiments are described in greater detail. In the following, the best mode for carrying out the present invention will be explained in detail, based on the drawings. In all drawings for explaining the best mode for carrying out the present invention, elements having identical functions are given identical designations and their redundant description is omitted.

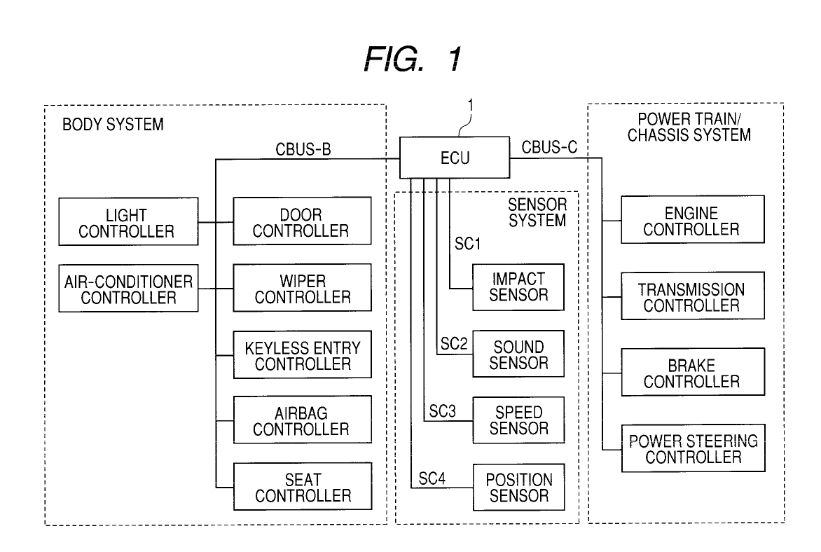

FIG. 1 shows an example of a network system which is used for electronic control of an automobile. An automobile electronic control unit (ECU) 1 detects vehicle conditions by input signals and, according to detected quantitative indications, performs control to adjust vehicular mechanisms such as an ignition mechanism, fuel system, and intake/exhaust system to operate in optimal conditions. To the automobile electronic control unit 1, information indicative of vehicle conditions acquired from respective functional parts coupled to each bus CBUS of a control area network (hereinafter referred to as CAN) which is one automobile network protocol and information of respective signals SCs acquired from a sensor system are input. To one of the CAN buses CBUSs, a bus CBUS-C for a power train/chassis system, an engine controller, a transmission controller, a brake controller, a power steering controller, and others, which are power train/chassis functional parts, are coupled. To a bus CBUS-B for a body system, a door controller, a wiper controller, a keyless entry controller, an airbag controller, a seat controller, a light controller, an air-conditioner controller, and others, which are body functional parts, are coupled. The respective signals SC from the sensor system are, inter alia, an impact sensor (GS) signal SC1, a sound sensor (MP) signal SC2, a speed sensor (SP) signal SC3, and a position sensor (PGS) signal SC4.

Further, the automobile electronic control unit 1 controls recording of information acquired from the respective functional parts of the power train, chassis, and body coupled to the CAN buses CBUSs (hereinafter referred to as CAN information) and information of the respective signals SC1 to SC4 (hereinafter referred to as SC information). Such information is used to investigate the cause of a vehicular accident or the like.

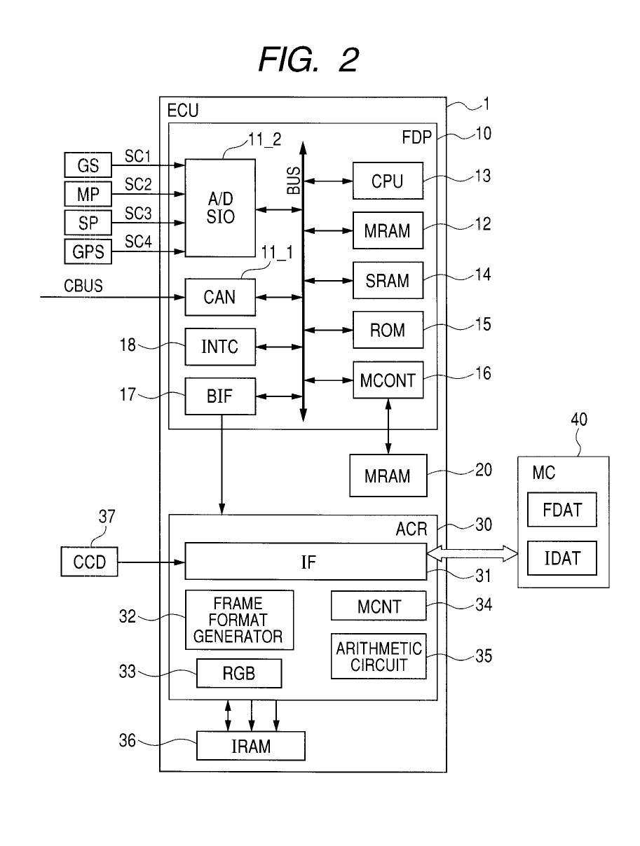

FIG. 2 illustrates a block diagram of an automobile recorder which is embodied by the above-described automobile electronic control unit 1. The automobile electronic control unit 1 comprises a data processor (FDP) 10, a working memory 20 coupled to the data processor 10, and an image processing accelerator (ACR) 30. To the automobile electronic control unit 1, a removable external storage device 40 like, e.g., a flash memory card is coupled. The data processor 10 controls the respective functional parts of the power train, chassis, and body to operate in optimal conditions. Moreover, it controls recording of necessary information acquired from these functional parts. The image processing accelerator 30 is responsible for control to record images captured by a CCD camera 37 equipped on the vehicle.

The data processor 10 comprises a central processing unit (CPU) 13 which exerts overall control, an SRAM (Static Random Access Memory) 14 which is a working storage area for the central processing unit 13, a ROM 15 for storing programs which are executed by the central processing unit 13, and an MRAM 12 which is used as a buffer RAM. The data processor 10 also comprises a memory controller (MCONT) 16 for interfacing with the working memory 20 and a buffer interface circuit (BIF) 17 for interfacing with the image processing accelerator 30. The data processor 10 further comprises a CAN interface circuit (CAN) 11_1 coupled to the above-mentioned CAN buses CBUSs, a sensor input circuit (A/D SIO) 11_2 to which the respective signals SC1 to SC4 are input from the above-mentioned sensor system, and an interrupt controller (INTC) 18 which outputs an interrupt signal to the central processing unit 13 in response to an interrupt request.

Input of the above-mentioned CAN information to the CAN interface circuit 11_1 is serially performed through the CAN buses CBUSs to which the respective functional parts of the power train, chassis, and body are coupled. The CAN interface circuit 11_1, for example, upon receiving a data packet from a CAN bus CBUS, derives necessary information from the received data packet; and after storing it in its internal data register, issues a receive interrupt request. When the interrupt controller accepts this receive interrupt request, it outputs an interrupt signal to the central processing unit 13. Thereby, the central processing unit 13 takes in the received data, identifies the source of the data and the data itself, and uses the data for internal control such as engine control. At the same time, if the received information is the one to be recorded, the CPU controls recording operation by the drive recorder. Whether or not it should be recorded is determined by an operation program of the central processing unit 13. The recording operation will be further detailed later. The data to be recorded is temporarily stored into the MRAM 12 which is controlled as a FIFO buffer. To avoid unintended erasure of old necessary data due to wrap-around control of the FIFO buffer, such data is transferred from the MRAM 12 to the working memory 20 as a secondary memory. Furthermore, to avoid that data existing on the working memory 20 is overwritten unintentionally, the data is transferred, if necessary, from the working memory 20 to the external storage device 40 as a tertiary memory. When the CAN interface circuit 11_1 receives control data and information as to what is controlled from the central processing unit 13, the CAN interface circuit 11_1 generates a packet, specifies the destination of the packet to send to, and sends the packet onto the appropriate CAN bus CBUS. In this way, the CAN interface circuit 11_1 controls sending of control data.

To the sensor input circuit 11_2, the above-mentioned SC information, namely, impact sensor signal SC1, sound sensor signal SC2, speed sensor signal SC3, position sensor signal SC4, which are respectively coupled, are selectively input. In the same way as for the CAN interface circuit 11_1, the sensor input circuit 11_2 informs the central processing unit 13 of signal reception by issuing an interrupt request. The central processing unit 13 performs internal control and recording of necessary information, based on the received data. The sensor input circuit 11_2 is configured with an A/D converter which converts an analog signal corresponding to the SC information into a digital signal, a serial communication interface circuit, and others. For example, when detected information is input from an acceleration sensor to the A/D converter and an “A/D conversion complete” interrupt signal is issued by the A/D converter, the central processing unit 13 obtains the converted data from the A/D converter and decides a degree of acceleration experienced by the car. According to the result of the decision, the central processing unit 13 can detect an abnormal condition such as collision, that is, a certain event occurrence.

Although not restrictive, criterion data that is used for decision of abnormality such as collision, information items (parameters) to be detected such as engine revolving speed and valve opening ratio and their controlled variables are generated by the central processing unit 13 with reference to a control table.

The recording operation by the drive recorder is further explained. The central processing unit 13 serially stores CAN information and SC information into the MRAM 12. The central processing unit 13 performs wrap-around control circulating the write address from the initial address to the end address in the storage area of the MRAM 12. Thereby, the newest CAN information and SC information and the CAN information and SC information that are the second newest, the third newest, and so on are stored on the MRAM 12.

The central processing unit 13 controls transfer of the CAN information and SC information being before overwritten by the wrap-around control to the working memory 20 via the memory controller 16. Thereby, it becomes possible to hold the CAN information and SC information on the working memory for a long period. As the working memory 20, a semiconductor memory such as SRAM and DRAM can be used. Among them, the use of an MRAM is preferable, considering that MRAM can be rewritten and read an unlimited number of times.

The central processing unit 13 also controls storing of the CAN information and SC information once transferred to the working memory 20 into the external storage device 40 via the memory controller and the buffer interface circuit 17. This control can be performed during a free time, while the CAN information and SC information are input to the CAN input circuit 11_1 and the sensor input circuit 11_2.

As for recording image information, the image processing accelerator 30 is responsible for the image processing. The image processing accelerator 30 comprises an interface circuit (IF) 31 coupled to an external camera (CCD) 37, a frame format generator 32 which converts acquired information into an image file, and an RGB converter (RGB) 33 which converts acquired image data into color image data to be displayed on a display or the like. Although not restrictive, the accelerator 30 includes a memory card controller (MCNT) 34. For detection of sound, position, and car speed, the accelerator 30 may receive necessary data and perform processing. Especially, as for impact detection, an arithmetic circuit 35 within the accelerator 30 may be responsible for processing. A RAM (IRAM) 36 serves as a frame buffer or the like which is used for image processing. Image information captured by the external camera 37, taken in via the interface circuit 31, is processed by the RGB converter 33 and the frame format generator 32, and then held on the RAM 36. The image information held on the RAM 36 is transferred to the external storage device 40 by the memory card controller 34.

The external storage device 40 holds the CAN information and SC information as well as the image information. The external storage device 40 is a storage device which is removable from the automobile electronic control unit 1 and may be, e.g., a memory card (MC), a hard disk (HDD), etc. By linking the external storage device 40 to a computer device such as a personal computer (PC), the CAN information and SC information as well as the image information can be analyzed easily. By the use of a memory having a large storage capacity, it is possible to hold the CAN information and SC information as well as the image information for a long period.

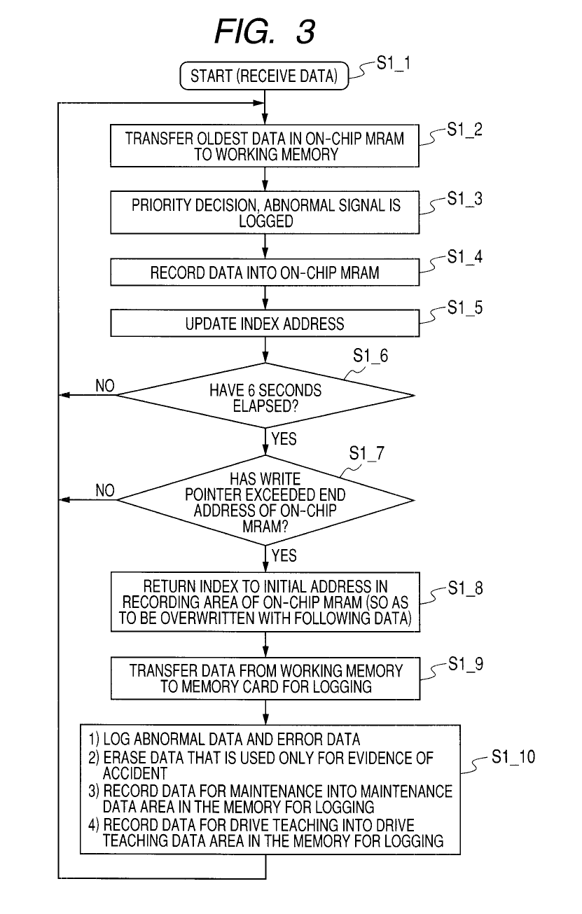

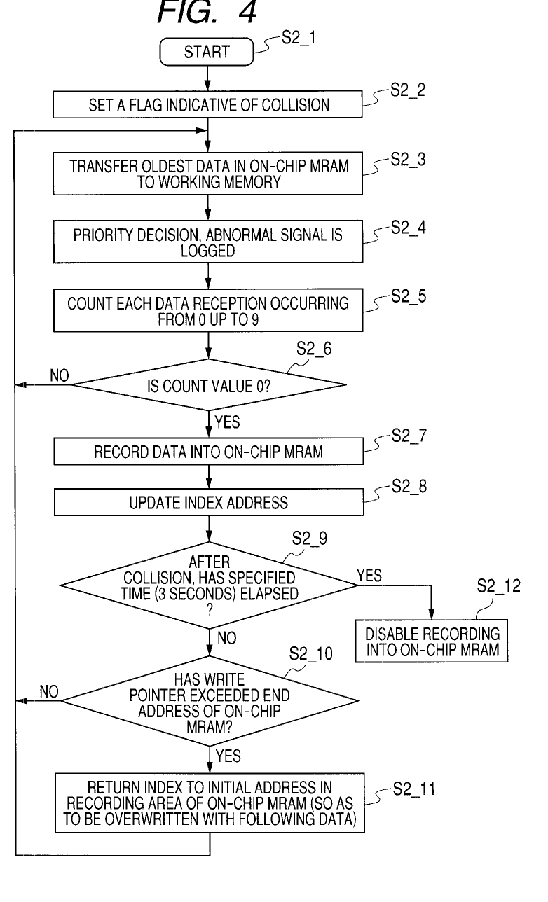

FIG. 3 shows a control flow of storing CAN information and SC information during ordinary operation. The central processing unit 13 stores CAN information and SC information into the MRAM 12 in a FIFO (First-in First-out) buffering manner. The central processing unit 13 has a write pointer and a read pointer for writing to and reading from the MRAM 12. The write pointer and the read pointer indicate an address of a location in the MRAM 12. The central processing unit 13 executes writing to the MRAM 12 by storing CAN or SC information in a location with an address indicated by the write pointer. Likewise, it executes reading from the MRAM 12 by reading CAN or SC information stored in a location with an address indicated by the read pointer. In the following explanation with regard to the flowchart shown in FIG. 3, it is assumed that the MRAM 12 has a memory capacity capable of storing information produced, for example, when the car travels for six seconds.

The central processing unit 13, in response to an interrupt request by, for example, the CAN interface circuit 11_1 of the sensor input circuit 11_2, starts control of storing CAN or SC information received by the interrupt requester (S1_1). First, the central processing unit 13 reads data at an address indicated by the read pointer from the MRAM 12 and transfers the data to the working memory 20 (S1-2). Then, the CPU decides priority of the received information (S1-3), controls writing of the received data at an address in the MRAM 12 indicated by the write pointer (S1-4), and increments an index address, that is, the read pointer value and write pointer value by one. After that, the CPU determines whether, for example, six seconds have elapsed from the beginning of the MRAM 12 (S1-6) and determines whether the write pointer of the MRAM 12 has reached the end address of the MRAM 12 to determine whether the MRAM 12 is full of information stored. The reason why both determination steps S1-6 and S1-7 are shown is that these steps are intended to note that the memory full state may be detected in terms of time or address. It should be understood that at least either step of this determination only has to be performed. If the MRAM has become full, the pointer is returned to the initial address so that, after the next reading, writing of data can be performed from the initial address of the MRAM 12. Because read and write are performed in pairs before a first cycle of write to the MRAM 12 over the range of addresses is completed, data saved to the working memory 20 during the first cycle becomes invalid. However, the central processing unit 13 only executes the same program processing for the first cycle and subsequent cycles. This can contribute to reduced program size or simplified program processing.

The central processing unit 13 transfers the CAN or SC information stored on the working memory 20 to the memory card, if necessary (S1_9). Transfer of the CAN or SC information from the working memory 20 to the memory card is performed when the bus is unoccupied.

FIG. 4 shows a control flow of storing CAN information and SC information when an event has occurred. It is again assumed that the MRAM 12 has a memory capable of storing information acquired for six seconds, as in the case of FIG. 3. Here, by way of example, the following explanation concerns a recording procedure that can preserve information acquired during three seconds before and three seconds after an event occurrence, a total of six seconds.

During control of storing of CAN information and SC information by the central processing unit 13 as described in FIG. 3, in case an event of a vehicle crash occurs or a collision flag is set and when CAN information or the like is received, the process illustrated in FIG. 4 is executed (S2_1). When at least either the impact sensor signal SC1 or the speed sensor signal SC3 is received, due to the fact that the central processing unit 13 detects an abnormal value such as rapid value change, an event occurs. Upon the event occurrence, the central processing unit 13 sets a flag indicative of collision (S2_2). Then, the central processing unit 13 executes the same steps as S1_2 and S1_3 in FIG. 3 (S2_3 and S2_4). The central processing unit 13 counts each data reception occurring, wherein the count starts with 0 and increments by one (S2_5). In this counting, a count value of 9 is followed by return to an initial value. Unless the count value is 0, steps S2-2 to S2-6 are repeated. Hence, once per ten times of receiving at the CAN interface circuit 11_1 which receives at predetermined time intervals, the process can go to step S2-7 and subsequent for storing received information into the MRAM 12. In short, received data shrunk by once per ten times is stored into the MRAM 12. Consequently, data that is stored into the MRAM 12 becomes intermittent, but a period during which data is acquired becomes longer by a factor of 10. Data received after the event occurs is shrunk in this way, because information acquired before and at the event occurrence is more important than that acquired after the event. Also because the vehicle can be assumed to stop after the event occurrence, such shrinkage of received data is believed not to result in a serious disadvantage.

Incrementing of the write pointer after writing in step S2-7 is the same as described above (S2_8). After that, the central processing unit 13 determines whether three seconds have elapsed after the collision (S2_9). If three seconds have elapsed after the collision, the CPU disables storing of CAN or SC information into the MRAM 12 (S_12). Thereby, the CAN or SC information acquired during three seconds before and after the event occurrence, for a total of six seconds, is held on the MRAM 12. Unless three seconds have elapsed after the collision, as determined in step S2-9, the central processing unit 13 determines whether the write pointer has exceeded the end address of the MRAM 12 (S2 10), as in step S1_7 in FIG. 3. If the write pointer does not exceed the end address, as determined in this step, the central processing unit 13 repeats the steps from S2_3 to S2_10. Otherwise, if it is determined that the write pointer has exceeded the end address, the central processing unit 13 updates the address indicated by the write pointer from the end address to the initial address (S2_11). After that, the central processing unit 13 repeats the steps from S2_3 to S2_11. That is, by disabling the storing operation at the point of time when information acquired for three seconds after the collision has been stored (S2_9, S2_12), preservation of earlier information for three seconds, acquired and stored before the collision, is assured. Even if wrap-around writing to the MRAM 12 is required, information acquired for three seconds after the collision can be preserved certainly (S2_10, S2_11).

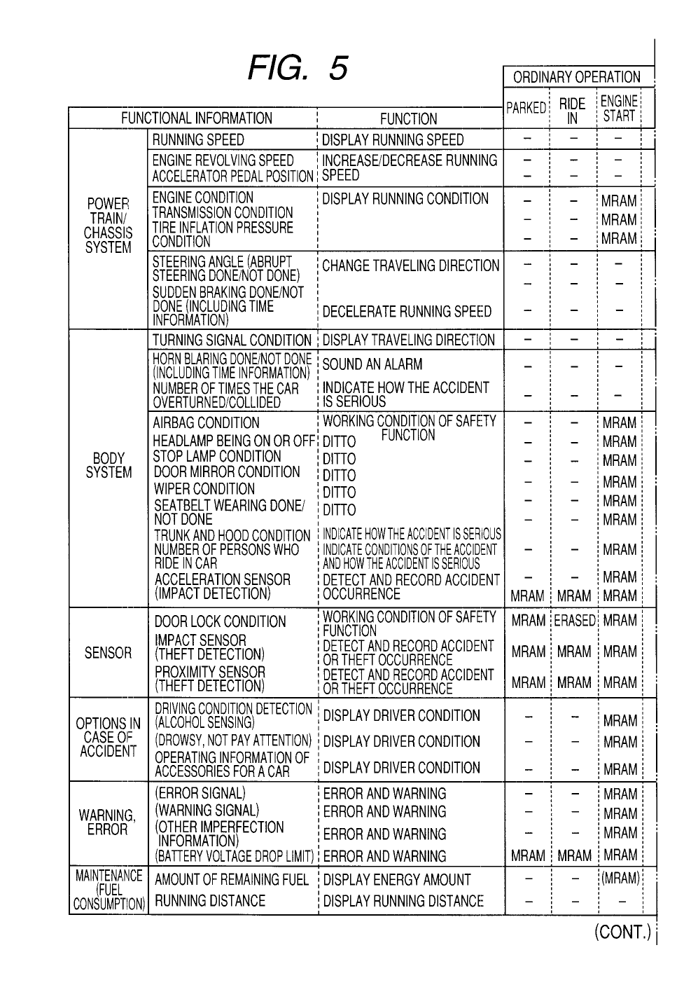

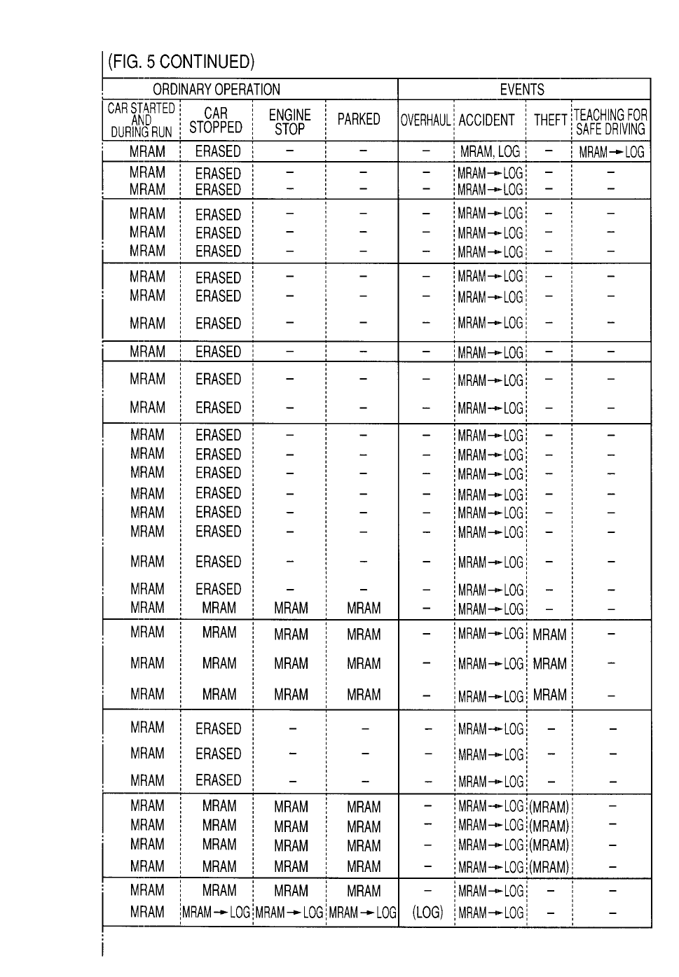

FIG. 5 shows detailed particular examples of information which are input via the CAN interface circuit 11_1 and the sensor input circuit 11_2 and exemplifies how respective items of information are recorded by the recorder differently depending on the automobile operating circumstances. In the figure, a notation “MRAM” means that information is stored into the MRAM 12 which is a primary memory and then transferred to the working memory 20. A notation “MRAM→LOG” means that information held on the working memory 20 is additionally transferred to the external storage device 40 as a tertiary memory.

As can be seen in FIG. 5, the respective items of information are stored when the car travels and the same items of information are stored before and after a collision, if happened. These items of information are finally transferred to the external storage device 40, but the recorded items of information remain on the MRAM 12 as well. Because the external storage device 40 is removable, the information recorded thereon is at a risk being juggled after the accident. On the other hand, access to the on-chip MRAM 12 itself built in the microcomputer from outside is not easy, the risk of the information recorded thereon being juggled after the accident is very low. Therefore, the drive recorder can ensure a high reliability of records used for proving or investigating the cause of an accident.

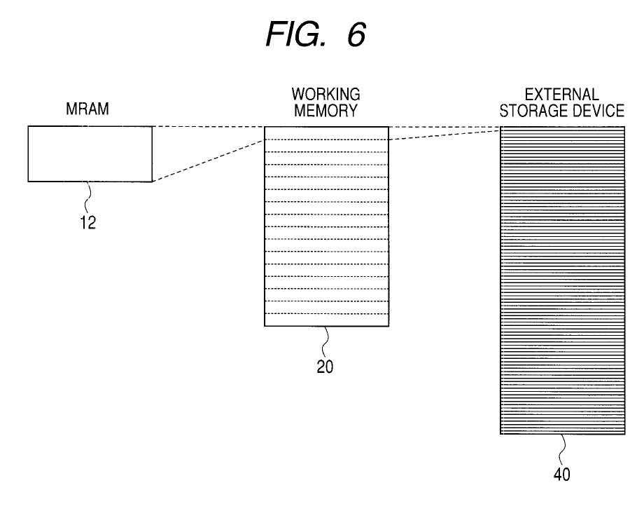

FIG. 6 shows a hierarchical structure of three stages of memories. The MRAM 12 is a buffer RAM as a primary memory, the working memory 20 is a secondary memory, and the external storage device 40 is a tertiary memory. In particular, the primary and secondary memories are formed as MRAMs with a relatively small storage capacity, and they can be rewritten an unlimited number of times. The tertiary memory is formed as a flash memory with a large storage capacity, but it will be rewritten a limited number of times. With regard to storage capacity, there is a relation that MRAM 12<working memory 20<external storage device 40. In the absence of the working memory 20, the number of times data held on the MRAM 12 having only a small storage capacity is written into the external storage device 40 increases and this accelerates the rate of progression of deterioration of the external storage device. Because the storage capacity of the working memory 20 is larger than that of the MRAM 12, accordingly, provision of the working memory 20 can slow down the rate of progression of performance deterioration of the external storage device 40. In this respect, the three-stage buffer structure shown in FIG. 6 has an advantage of extending the life of the external storage device 40.

While the invention made by the present inventors has been described specifically based on its embodiments hereinbefore, it will be appreciated that the present invention is not limited to the described embodiments and various modifications may be made without departing from the gist of the invention.

Although the case has been described above where three memories, namely, the MRAM 12, the working memory 20, and the external storage device 40 are employed, the present invention is not limited to this case and can be applied to, for example, a case where two or more memories including the MRAM 12 are employed.

Although MRAMs are selected as the MRAM 12 and the working memory 20, as described, this is because MRAMs are most suitable for carrying out the present invention at the point of time of completion of the invention. The MRAM 12 can be replaced by any other nonvolatile memory which can be incorporated as an on-chip memory in the data processor 10 and can be rewritten an unlimited number of times. Such nonvolatile memory which can be rewritten an unlimited number of times refers to a nonvolatile memory having a guaranteed number of times of rewrite that is significantly larger than the guaranteed number of times of rewrite of, e.g., a flash memory. The working memory 20 is not required to be an on-chip memory which can be incorporated in the data processor and can be replaced by a nonvolatile memory which can be rewritten an unlimited number of times.

As an alternative to the working memory 20, for example, it is thought that a phase-change memory can be used. This memory also can be used as an alternative to the MRAM 12, if it can be incorporated as an on-chip memory in the data processor.

The external storage device 40 can be replaced by a nonvolatile storage medium which is inexpensive and has a large capacity, instead of a flash memory or a hard disk drive.

In FIG. 3, the case has been described where CAN or SC information is stored into the MRAM 12 and transferred therefrom to the working memory 20 address by address in a FIFO buffering manner. This is not restrictive and, if the amount of CAN or SC information stored on the MRAM 12 has reached a specified capacity, the CAN of SC information may be transferred to the working memory 20. For example, when the amount of CAN or SC information stored on the MRAM 12 has reached the end address, all the CAN of SC information stored in locations from the initial address to the end address can be transferred in a batch to the working memory 20.

In FIG. 4, the central processing unit 13 may transfer the CAN or SC information stored on the working memory 20 to the external storage device 40 during a free time, as already stated above, or after storing of data into the MRAM 12 is disabled. Thereby, there is no need for analyzing the CAN or SC information stored on the working memory 20.

The automobile recorder of the present invention is applicable to, besides the automobile drive recorder, a flight recorder for aircraft, a recorder equipped on a vehicle or vessel such as a bicycle, motorcycle, and ship, a recorder for storing temperature, wind velocity, vibration, sound, etc. in case of a disaster, and others.

What is claimed is:

1. An automobile recorder for recording vehicle conditions comprising:
a one-chip data processor coupled to signal lines transmitting functional information relevant to functional parts mounted in the vehicle; and
an external memory coupled to the data processor,
wherein the data processor comprises: an input circuit which input a functional information from the signal lines; an internal memory comprising an MRAM for temporarily storing the functional information taken in by the input circuit from the signal lines; and a central processing unit,
wherein the central processing unit performs storing control for storing the functional information into the internal memory while circulating a access address ranging from an initial address to an end address, saving control for saving the functional information from the internal memory to the external memory before being overwritten by the access address circulation, and disabling control for disabling storing of functional information by the storing control when the amount of new information being stored in the internal memory by the storing control has reached to a specified quantity in response to a certain event occurrence, and
wherein the specified quantity is less than a storage capacity ranging from the initial address up to the end address.

2. The automobile recorder according to claim 1, wherein the specified quantity is specified in terms of time that elapses after the certain event occurrence.

3. The automobile recorder according to claim 1, wherein the specified quantity is specified in terms of the number of times the memory is accessed after the certain event occurrence.

4. The automobile recorder according to claim 1, wherein the central processing unit includes a first register in which control data for determining the specified quantity is set programmatically.

5. The automobile recorder according to claim 1, wherein the input circuit includes a second register in which selection control data for selectively inputting one of a plurality of items of functional information transmitted through the signal lines is set programmatically.

6. The automobile recorder according to claim 1, wherein the central processing unit reduces the frequency of storing functional information by the storing control, which is performed in response to the certain event occurrence, in comparison with the frequency of storing functional information by the storing control before the event occurrence.

7. The automobile recorder according to claim 1, wherein the functional information comprises one or more items of control information among power train system control information, chassis system control information, and body system control information.

8. The automobile recorder according to claim 1, wherein the central processing unit recognizes the occurrence of the certain event by the fact that a value of acceleration acquired from an acceleration sensor or a value of impact acquired from an impact sensor has exceeded a predefined value.

9. The automobile recorder according to claim 1, wherein the external memory comprises an MRAM.

10. An automobile recorder for recording vehicle conditions comprising:
a data processor coupled to signal lines transmitting functional information relevant to functional parts mounted in the vehicle and having an on-chip buffer memory comprising an MRAM for temporarily storing the functional information taken in from the signal lines;
a working memory which is coupled to the data processor and to which the functional information held on the buffer memory is transferred; and
an external storage device for storing the functional information once held on the working memory.

11. The automobile recorder according to claim 10, wherein the data processor performs storing control for storing the functional information into the buffer memory while circulating a access address ranging from an initial address to an end address, saving control for saving the functional information that is going to be overwritten from the buffer memory to the working memory by the access address circulation, disabling control for disabling storing of functional information by the storing control when the amount of new information being stored on the buffer memory by the storing control has reached a specified quantity that is less than a storage capacity ranging from the initial address up to the end address in response to a certain event occurrence, and logging control for selectively storing the functional information held on the working memory into the external storage device.

12. A buffer memory system comprising:
a first memory comprising an MRAM;
a second memory comprising an MRAM into which a data held on the first memory is written and which has a larger storage capacity than the first memory; and
a third memory comprising an nonvolatile memory into which a data held on the second memory is written and which has a larger storage capacity than the second memory, but can only be rewritten a significantly smaller number of times in comparison with MRAM.

13. The buffer memory system according to claim 12, wherein the third memory is a flash memory card.

14. The buffer memory system according to claim 12, wherein the first memory implemented in a semiconductor integrated circuit is an on-chip memory included in a microcomputer chip.

15. The buffer memory system according to claim 12, wherein the second memory is a memory externally coupled to the microcomputer.
